(19) United States
(12) Patent Application Publication
(10) Pub. No.: US 2008/0170826 A1
(43) Pub. Date: Jul. 17, 2008

(54) Misalignment-tolerant optical coupler/connector

(75) Inventor: David Schaafsma, Fallbrook, CA (US)

Correspondence Address: David Schaafsma, 744 Stewart Canyon Rd., Fallbrook, CA, 92028, US

(73) Assignee: Applied Optical Materials, Fallbrook, CA (US)

(21) Appl. No.: 11/653,324

(22) Filed: Jan. 16, 2007

(51) Int. Cl. G02B 6/38

(52) U.S. Cl. 385/70

(57) ABSTRACT

A non-imaging optical coupling device for use in i.e., optical communications, laser power delivery, laser radar (lidar), and other applications that is relatively immune from optical misalignment and therefore does not need sophisticated splicing or connectorization apparatus is described.

### FIELD OF THE INVENTION

This invention relates generally to the fields of optics, telecommunications, and fiber optics and in particular to an apparatus that couples light from one or more fibers into another fiber with high efficiency and high tolerance to misalignment of the fibers on either side.

### BACKGROUND OF THE INVENTION

Traditional glass fiber optics require fusion splicing or connectorization involving polishing to achieve low loss optical interconnect between two distinct fibers. These options are time consuming, costly, and require considerable training for technicians to be able to perform the tasks well. The industry has long sought a fiberoptic equivalent of electrical connectors that twist, crimp, glue or otherwise mate two connectors through a simple “butt splice” method, but with fibers the issue of alignment and coupling must be addressed. This cannot be done using conventional optics such as lenses since these components do not provide the misalignment (both position and angle) tolerance needed for a robust field splice.

In conventional fiber splices, the ends of the fiber are cleaved to create a clean, smooth surface and then joined by fusing the glass fibers together with an electric arc or similar means. This creates a continuous waveguide but the fibers must be precisely aligned to begin with, often using large and costly equipment. Fiber mechanical connectors often use “butt coupling,” where the ends of two fibers prepared with flat or angled facets (either cleaved or polished) are brought into very close proximity. This requires a system for connectorizing the fiber, which can also be costly and bulky.

Grating couplers have been widely used in conventional beam combining technology, but always (to our knowledge) in free-space configurations or for coupling fiber to waveguides. Typically, multiple beams are directed at or focused onto a grating which is designed to diffract significant parts of each beam in the same output direction. The use of planar reflective gratings for coupling between fibers was disclosed by Bowen et al in U.S. Pat. No. 5,011,255 (Apr. 30, 1991), but their approach used fibers oriented in the same direction, with the reflection from the grating used to steer the beam from one fiber to the other. A similar approach was disclosed by Kompfner in U.S. Pat. No. 4,337,993 on Jul. 6, 1982.

In-fiber gratings have also been used for coupling purposes, but these require the diffractive structure to be physically inscribed in photosensitive optical fiber using high laser fluence. An example of such a coupler is the prior art developed by Ohta et al (U.S. Pat. No. 7,113,674 issued Sep. 26, 2006), wherein two fibers are brought in proximity and inscribed with a slanted Bragg grating structure to achieve coupling. Similar approaches were disclosed by Kewitsch et al (U.S. Pat. No. 6,578,388, of Jun. 17, 2003), Stowe et al (U.S. Pat. No. 6,445,855, Sep. 3, 2002), by Lauzon (U.S. Pat. No. 5,764,831, of Jun. 9, 1998), Bricheno et al (U.S. Pat. No. 5,633,965, May 27, 1997), and by Snitzer (U.S. Pat. No. 5,459,801, Oct. 17, 1995).

Fiber-to-waveguide coupling using diffractive structures was disclosed by Taillaert et al in U.S. Pat. No. 7,065,272 (issued Jun. 20, 2006), using a regular array of index variations in the slab waveguide material, such as a pattern of etched “dots” or “pillars” on the surface of the material. A similar approach was disclosed by Gunn et al in U.S. Pat. No. 7,006,732, issued Feb. 28, 2006. A transmissive diffractive lens structure was disclosed by Coleman in U.S. Pat. No. 6,956,992 (Oct. 18, 2005).

The subject invention is a novel interconnect using micro-diffractive optics to achieve very high misalignment tolerance with low insertion loss. These coupling devices have the potential to not only allow efficient passive beam combining, but also to solve many illumination and laser delivery problems such as bending in hollow waveguides. Furthermore, the geometry of the device allows for multiple fiber sources to be combined in a very rugged way, free from the vibration and occlusion problems of free-space optics.

All of the conventional systems described above have a large degree of misalignment sensitivity, which requires that the fibers be held in precise alignment with each other in order to preserve good coupling efficiency. The use of lenses or reflecting optics can help to some degree, but there is a basic limitation on how well this type of system can tolerate misalignment.

The fundamental physical constraint on conventional optical coupling systems is the conservation of optical throughput, known from the so-called Lagrange invariant of geometric optics, which can be derived from first principles. In mathematical terms, the conservation of optical path between two media C₁ and C₂ with boundary K is governed by

$${\int }_{{C}_{1}} {n}_{1} {s}_{1} \cdot d r + {\int }_{{C}_{2}} {n}_{2} {s}_{2} \cdot d r + {\int }_{K} ( {n}_{2} {s}_{2} - {n}_{1} {s}_{1} ) \cdot d r = 0 , \qquad ( 1 )$$

where n is the refractive index, and s is the ray vector. The throughput, or the product of angular acceptance and optical aperture, in a non-diffractive optical system is limited by the component with the smallest throughput, so that

$${\int }_{{C}_{1}} {n}_{1} {s}_{1} \cdot d r + {\int }_{{C}_{2}} {n}_{2} {s}_{2} \cdot d r = 0. \qquad ( 2 )$$

This formulation is equivalent to the so-called Liouville form of non-imaging optics, wherein conservation of refractive and reflective systems is often expressed as

n₁d₁ sin α=n₂d₂ sin β, (3)

where n₁ and n₂ are the refractive indices of the media on either side of the system, d₁ and d₂ are the entrance and exit aperture widths of the system, respectively, and α and β are the angles over which the input and output beams are distributed. This derivation is based on the Liouville theorem, which applies to conformal transformations between three-dimensional spaces. Reflectors, lenses, Fresnel lenses, and similar optical instruments are all limited by this constraint.

Of critical importance in Eq. 1 is the surface K, which in refractive and reflective optics cannot alter the wavevector ns. In diffractive optics, the surface K can cause discontinuity in ns, thereby allowing a different conservation relationship. Diffractive optics provide the only means by which this constraint may be relaxed to allow larger angles and areas to be converted to smaller angles and areas, or a larger mode distribution to be condensed into a smaller distribution of degenerate modes.

Furthermore, the problem of coupling into fiber or waveguide structures has been typically approached from an imaging perspective; in essence, there is usually an implicit or explicit requirement to produce an image on the entrance facet of the waveguide. Non-imaging optics have not been used widely for this purpose, though there is an inherent match, since the entirety of the optical coupling process does not occur exactly at the entrance facet but is in fact distributed some depth into the waveguide. Non-imaging methods, which typically produce longer and less divergent “waist” regions thus have a better overlap with this extended coupling in waveguides than imaging methods, which commonly exhibit highly divergent evanescent penetration.

Though a great deal of prior art exists in the general area of efficient coupling to fiber, there exists a continuing need for optical coupling structures providing high efficiency, while eliminating the need for fusion splicing, polishing, and precise alignment. Such structures would represent a significant advance in the art. The present invention represents a fundamental departure from prior art at the level of basic physical principles as well as structural design of the system.

### SUMMARY OF THE INVENTION

I have developed, in accordance with the principles of the invention, an optical coupling device for use in, i.e., telecommunications, fiber optic systems, laser power delivery, laser radar (lidar), and optical communications applications. In sharp contrast to prior art devices, my inventive coupler is a non-imaging, non-planar, high acceptance angle device. Consequently it is relatively immune from optical source incidence angles and therefore does not require precise alignment of the input and output fibers.

### BRIEF DESCRIPTION OF THE DRAWINGS

A more complete understanding of the present invention may be realized by reference to the accompanying drawings in which:

FIG. 1 shows a conceptual diagram of how the device steers light from one fiber to another with high tolerance for misalignment of the fiber;

FIG. 2 shows a conceptual ray tracing of how light is diffracted inside the device;

FIG. 3 shows the convention for different types and orders of reflection and diffraction;

FIG. 4 shows an alternate embodiment of the device with different geometry in the diffracting region;

FIG. 5 shows a device where multiple beams are combined and output into a single fiber; and

FIG. 6 illustrates the use of a further diffractive structure or lens element to match a lower numerical aperture fiber.

### DETAILED DESCRIPTION

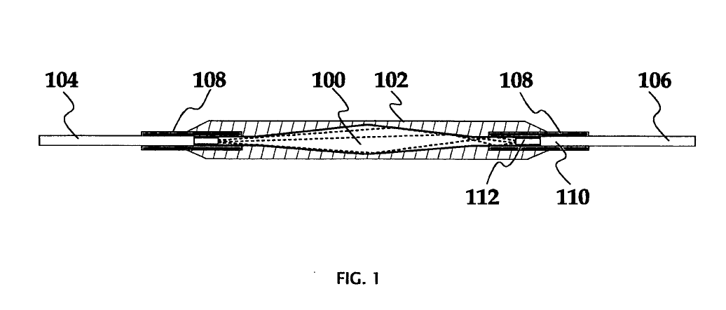

FIG. 1 shows a conceptual view of the coupler. A hollow region 100 or tube is enclosed in a solid body 102 with a diffractive surface. The ends of solid body 102 are open so that optical fibers 104 and 106 can be inserted into the device and securely mated using a crimp sleeve 108, mating to either the fiber jacket 110 or the fiber buffer or cladding 112 or both, or a similar mating device.

Light emanating from fiber 104 spreads out in a conical distribution as determined by the numerical aperture of the fiber. Rays from fiber 104 strike the interior diffractive surface of the solid coupler body 102 and are either reflected or diffracted from the surface or absorbed by it, according to the diffractive characteristics of the surface. Rays which are diffracted are steered closer to the corresponding input cone of fiber 106, determined by its numerical aperture. Rays which are reflected are then directed to another area of the diffractive surface on the interior of coupler body 102 and may thence be reflected or diffracted again. The cumulative effect of multiple reflection and diffraction events averaged over many light rays emanating from fiber 104 is to direct the majority of such rays into the acceptance cone of fiber 106 so that efficient capture of the light from fiber 104 by fiber 106 may occur. In general, as long as the exit apertures of the tube 100 remain approximately aligned with the fibers, efficient coupling will occur, so that the midsection of tube 100 can be allowed to flex.

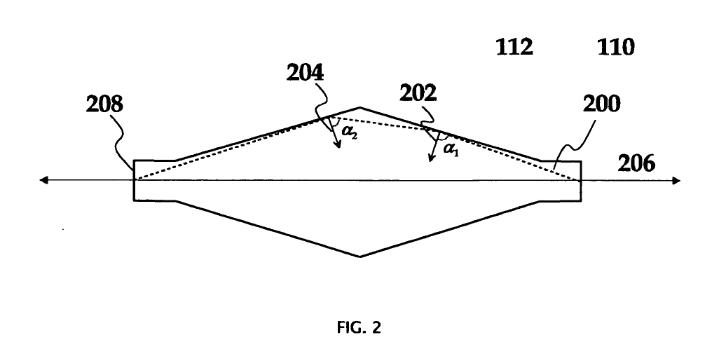

FIG. 2 illustrates the process by which a single ray may be directed from one fiber to the other. As noted above, the interior surface of hollow region 100 is diffractive, such that ray 200 striking the interior of the tube at an angle α with respect to the surface normal 202 or 204 is at least partially diffracted at a higher angle β. In the proximal section of tube 100 rays strike the diffractive surface at a glancing angle (such that angle α₁ is nearly 90 degrees) with respect to normal 202, which in most cases will mean that little diffraction occurs. However, once the ray is past the center of hollow region 100 where the angle of the surface normal 204 of tube or cavity 100 with respect to the center axis 206 changes, it will strike the surface at a shallower angle. Thus, ray 200 striking the surface of hollow region 100 at an angle α₂ with respect to surface normal 204 can be diffracted in a positive direction toward the exit aperture 208 of hollow region 100.

It will be apparent to skilled practitioners that this process will occur in fundamentally the same manner if the center axis 206 of hollow region 100 is bent or curved in a given direction. In fact, some advantage may be gained by increasing the average angle α₂ at which the rays are incident on the distal portion of the tube. This characteristic is wholly different from a reflective structure of the same geometry. In the case of a pure reflective structure, a multitude of cases exist where all or a majority of rays will not reach exit aperture 208 if center axis 206 is bent or curved. Even when center axis 206 is predominantly unbent, the diffractive effect of the surface of region 100 will ensure that the total angular spread Ω of rays is smaller than the corresponding spread for a reflective surface.

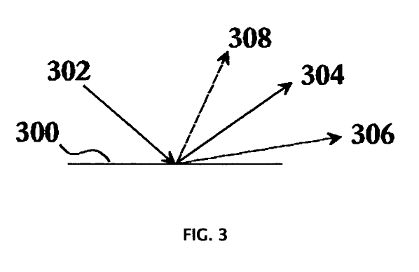

It will be apparent to skilled technicians that the diffractive surface 300 on the interior of hollow region 100 must be optimized to reduce negative diffraction, or diffraction of rays in a direction proximal of the specular ray 304 with respect to the incident ray 302, as shown in FIG. 3. Equivalently, the desired diffractive effect is a positive one, where diffracted rays 306 are directed along an angle greater than the specularly reflected ray 302, rather than in a negative direction as indicated by ray 308. Proper grating design to maximize positive diffraction will in many cases also have the effect of directing scattered light substantially more toward the output of the tube rather than the input.

For a diffraction grating, there will be an angular cutoff such that more oblique incidence angles cannot satisfy the grating equation

$$\frac{m λ}{d} = sin α + sin β , \qquad ( 4 )$$

where m is the diffraction order, λ is the incident wavelength, d is the grating spacing, α is the incident angle and β is the diffracted angle. The angular cutoff occurs at

$$α = {sin}^{- 1} ( \frac{m λ}{d} ) , \qquad ( 5 )$$

so that for a particular design wavelength λ and grating spacing d, the most oblique angle at which an incident ray can be diffracted will occur when m=1. One simple method to increase diffraction at high angles is to use a second order grating, where the peak diffraction efficiency at shallow incidence is in the 2^{nd} order, while the peak at higher incidence angles is in the first order. This approach can also obviously be extended to third order and higher, though at some cost of overall efficiency and unwanted orders.

Several grating design variations may also be used to optimize the multiple diffraction effect. In particular, the angular distribution of rays striking the inner surface of hollow region 100 near the midsection will be greater than the angular distribution of rays striking the inner surface of hollow region 100 near exit aperture 208, due to the diffractive effect. This means that while the grating must be designed to diffract efficiently over a wide range of angles, at the midsection of hollow region 100, it can be designed for much higher efficiency at glancing incidence farther down the tube, closer to exit aperture 208.

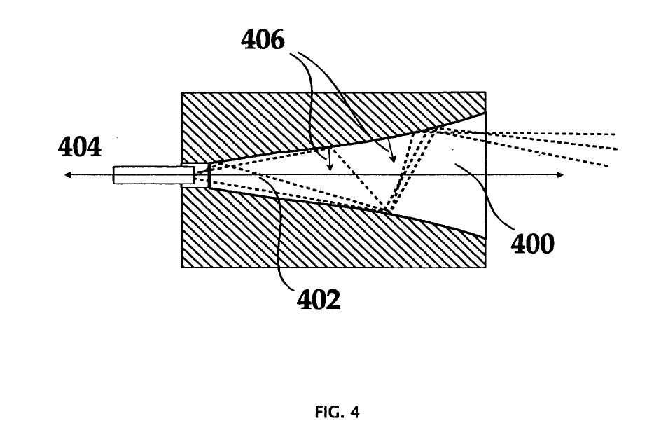

Likewise, the length and width of the tube can be optimized for given materials and geometries. As is known from the technology of hollow waveguides, longer tubes will result in greater interaction of the light with the sides of the tube, or a greater number of reflections or diffractions and thus greater loss. At the same time, the multiple diffraction effect will require a certain number of diffraction events in order to confine a given percentage of incident beams into a cone of a given output angle or numerical aperture (NA). Several variations of this basic concept are also encompassed within the present invention, including taper profiles for the basic conic shape, which may be parabolic, hyperbolic, exponential, or a general power series function. As illustrated in FIG. 4, geometries such as an exponential taper 400 may improve efficiency by decreasing the output NA. This effect can be understood by observing that diffracted rays 402 will more closely approach parallelism with waveguide axis 404 as the surface normal 406 more closely approaches perpendicularity with waveguide axis 404. Near-collimated rays produced by an exponential taper 400 may also be more easily refocused by a fixed optic such as a lens or diffractive optical element, as described further below.

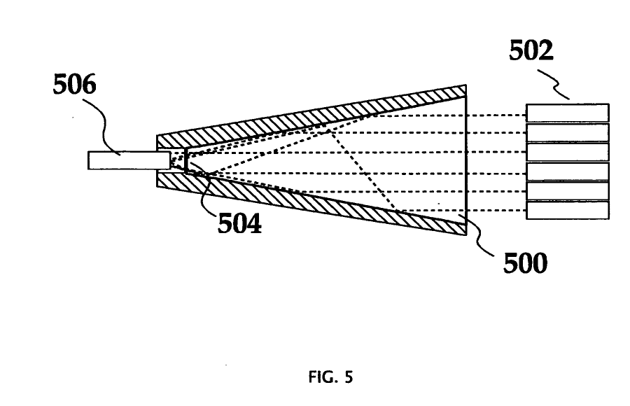

A second embodiment of the device is shown in FIG. 5. In this case, a half-conic shape 500 can be used to guide light from a plurality of fibers or sources 502 into a single exit aperture 504 and thence into a single fiber or waveguide 506. The basic physics of this process can be well understood by skilled practitioners given the preceding discussion. It will also be apparent that this device does not possess the same symmetry as the first embodiment; light emanating from fiber or waveguide 506 will not be coupled as efficiently into a plurality of guides 502, due to limitations of subtended area (packing fraction) and NA matching. Other methods such as coupling lenses, lenslets, diffractive optical elements or similar means may be used to improve the symmetry of this device and are also an object of this invention.

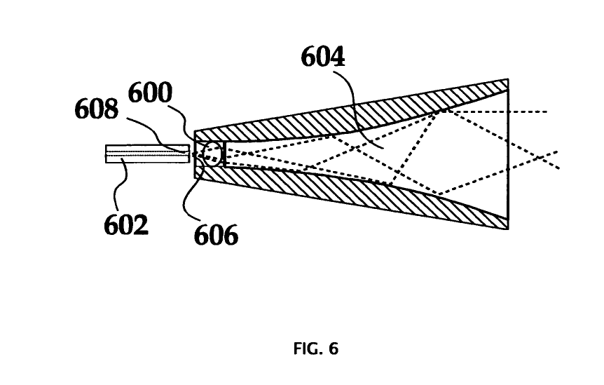

A further modification of my invention, as shown in FIG. 6, uses a focusing optic 600 to couple into a waveguide 602 of smaller area cross sectional area, such as a single mode or small-core fiber. It will be appreciated by skilled practitioners that a diffractive hollow tube 604 tightly coupled to a focusing optic will produce a more stable output than a corresponding imaging or relay system consisting of multiple focusing optics. Thus, the spot or circle of least confusion 606 produced by this method will move less than a corresponding spot produced by a relay configuration, relative to the input aperture 608 of the waveguide 602. Mechanical alignment of the waveguide 602 within a given tolerance, for example using a metal ferrule to house the fiber and the coupler, to spot 606 can then be used to achieve efficient coupling into a small guide.

At this point, while I have discussed and described my invention using some specific examples, those skilled in the art will recognize that my teachings are not so limited. Accordingly, my invention should be only limited by the scope of the claims attached hereto.

What is claimed is:

1. An apparatus for coupling or directing light from one waveguiding structure to another, consisting of:
a hollow structure, defining an interior surface; and
one or more light sources emitting a spread of rays into the hollow region;
a diffracting medium, disposed on the interior surface of the hollow structure;
such that light rays striking the interior of the hollow structure are directed to a common point, said common point being substantially an exit aperture of the hollow structure, along ray paths which are substantially aligned within the acceptance solid angle of a waveguiding structure situated at or near the exit aperture of the structure.

2. The apparatus of claim 1, where the diffractive surface of the tube is made from a surface relief grating, a volume holographic structure, a photonic bandgap structure, or similar material designed to diffract principally in a direction away from the specular reflection from the surface.

3. The apparatus of claim 1, where the hollow structure defines an interior shape which is bi-conic, bi-exponential, bi-parabolic, bi-hyperbolic, or any other quasi-symmetric structure based on a power series profile.

4. The optical apparatus of claim 1, where a lens or focusing optic is used in conjunction with the hollow structure to achieve a finer or smaller point of focus or least confusion.

5. An apparatus for coupling or directing light from one or a plurality of sources to a waveguiding structure, consisting of:
a hollow structure, defining an interior surface; and
one or more light sources emitting a spread of rays into the hollow region, either in free space or through waveguides;
a diffracting medium, disposed on the interior surface of the hollow structure;
such that light rays striking the interior of the hollow structure are directed to a common point, said common point being substantially an exit aperture of the hollow structure, along ray paths which are substantially aligned within the acceptance solid angle of a waveguiding structure situated at or near the exit aperture of the structure.

6. The apparatus of claim 5, where the diffractive surface of the hollow structure is made from a surface relief grating, a volume holographic structure, a photonic bandgap structure, or similar material designed to diffract principally in a direction away from the specular reflection from the surface.

7. The apparatus of claim 5, where the hollow structure defines an interior shape which is conic, exponential, parabolic, hyperbolic, or any other structure based on a power series profile.

8. The optical apparatus of claim 5, where a lens or focusing optic is used in conjunction with the hollow structure to achieve a finer or smaller point of focus or least confusion.

9. A method of collecting optical energy comprising the steps of:
receiving the optical energy on a hollow structure having a diffractive surface for receiving the optical energy;
directing the optical energy by scattering, reflecting, coherently reflecting, diffracting, or any combination thereof, to a common point which is substantially an exit point of the hollow structure, such that the rays exiting the hollow structure are substantially directed within the acceptance solid angle of a waveguiding structure situated at or near the exit aperture of the structure;
so that the light received by the hollow structure is directed substantially into the waveguiding structure at the exit of the hollow structure.

10. The method of claim 10, where the diffractive surface of the tubular structure is made from a surface relief grating, a volume holographic structure, a photonic bandgap structure, or similar material designed to diffract principally in a direction away from the specular reflection from the surface.

11. The method of claim 10, where the hollow structure defines an interior shape which is either wholly or partly conic, exponential, parabolic, hyperbolic, or any other structure based on a power series profile.

12. The method of claim 10, where a lens or focusing optic is used in conjunction with the hollow structure to achieve a finer or smaller point of focus or least confusion.
